(19) United States
(12) Patent Application Publication
(10) Pub. No.: US 2025/0115249 A1
(43) Pub. Date: Apr. 10, 2025

(54) SYSTEMS, METHODS, AND DEVICES FOR VEHICLE MONITORING AND CONTROL

(71) Applicant: Allstate Insurance Company, Northbrook, IL (US)

(72) Inventors: Timothy W. Gibson, Barrington, IL (US); Anasa Shank, Centennial, CO (US); Narayanan Alwar, Bloomingdale, IL (US); Matei Stroila, Chicago, IL (US)

(21) Appl. No.: 18/903,433

(22) Filed: Oct. 1, 2024

Related U.S. Application Data
(60) Provisional application No. 63/543,141, filed on Oct. 9, 2023.

(51) Int. Cl. B60W 40/09; B60W 30/08; H04W 4/40

(52) U.S. Cl. CPC B60W 40/09; B60W 30/08; H04W 4/40

(57) ABSTRACT

Implementations described herein provide systems, methods, and devices for vehicle monitoring and control based on advanced driving assistance system (ADAS) feature usage. The systems, methods, and devices include a driving data collection system for collecting driving-related data from an original equipment manufacturer (OEM) server and/or a mobile device. The OEM server receives the ADAS-related data from the vehicle and sends the ADAS-related data to the vehicle monitoring and control platform. Systems also include a vehicle/driver operation assessment system which uses one or more first deep-learning models to generate vehicle operation behavior values from the ADAS-related data. Furthermore the systems include a dynamic risk control model which uses one or more second deep-learning models to generate target outputs based on the vehicle operation behavior values. The target outputs include modification or control of the vehicle operations, one or more alerts, and/or a pricing variable.

### CROSS-REFERENCE TO RELATED APPLICATIONS

The present application claims priority to U.S. Provisional Patent Application No. 63/543,141, entitled “SYSTEMS, METHODS, AND DEVICES FOR VEHICLE MONITORING AND CONTROL” and filed on Oct. 9, 2023, which is specifically incorporated by reference herein in its entirety.

### FIELD

Aspects of the present disclosure relate to systems for vehicle monitoring and control, and more particularly, to monitoring and controlling vehicles with advanced driving assistance systems.

### BACKGROUND

Vehicles typically include a variety of assisted driving features to improve safety. However, many of these features have option settings that can be adjusted by the driver, such that the effect of the assisted driving features is minimized or disabled altogether. As such, it is typically difficult for third parties to determine whether a driver is actually using the assisted driving features included in their vehicle, whether the assisted driving features substantively affect the safety of the driver, or to what degree the assisted driving features affect the safety of the driver.

It is with these observations in mind, among others, that aspects of the present disclosure were conceived and developed.

### SUMMARY

Implementations described and claimed herein address the foregoing by providing systems and methods for vehicle monitoring and control. For example, a system can include a vehicle monitoring and control system obtaining a plurality of driving-related inputs of data collected from one or more data sources, the one or more data sources including a component of an advanced driving assistance system (ADAS) operating in a vehicle; a controller having at least one processor, the controller determining one or more vehicle operation behavior values based on the plurality of driving-related inputs, the one or more vehicle operation behavior values corresponding to one or more risk-related events identified from the plurality of driving-related inputs; and/or one or more deep-learning models generating an ADAS-based target output based on the one or more vehicle operation behavior values and the plurality of driving-related inputs, wherein an indication of the ADAS-based target output is generated for presentation.

In one implementation, the one or more data sources further includes a mobile device associated with a driver of the vehicle and an original equipment manufacturer (OEM) server; the plurality of driving-related inputs includes location data from the mobile device and ADAS usage data from the OEM server; and/or the one or more deep-learning models combine the location data with the ADAS usage data to identify the one or more risk-related events. Location data related to ADAS events can be collected such that that the system can compute location contextualized ADAS features, such as a number of pre-crash alerts on highways and/or a number of pre-crash alerts on local roads. A time of the event can also be used as inputs to the systems disclosed herein, for instance, to compute features occurring at night versus features occurring during daylight time. The ADAS events can also be contextualized for a particular season. Additionally, the component of the ADAS can include at least one of an adaptive cruise control system, a forward collision warning alert system, an automatic emergency braking system, an anti-lock brake system, a lane keeping assist system, a lane departure warning alert system, a vehicle stability control system, a traction control system, a wiper system, or other vehicle systems (e.g., which can be designed by manufacturers of the vehicle). The one or more vehicle operation behavior values can also include a ratio calculated using a number of ADAS feature activations of the ADAS. Furthermore, the number of ADAS feature activations can include at least one of a number of traction control activations or a number of automatic brake activations. The ratio can be calculated using the number of ADAS feature activations over a predefined number of uses.

In one implementation, the ADAS-based target output includes at least one of an alert message sent to one or more mobile devices, an update to a risk map presented at the display, a request for assistance sent to an emergency response device, a tow request sent to a device associated with a towing service, an instruction to perform an autonomous car action, or a pricing variable for an insurance pricing model, another device remote or separate from the system, and/or combinations thereof. In some scenarios, the pricing model can comprise one or more Generalized Linear Models which can include deep learning. Moreover, the computing system can include a mobile device associated with a driver or a passenger of the vehicle, the display can be a touchscreen of the mobile device, and/or the system can further include a wireless network connection between the mobile device and the vehicle, at least some of the plurality of driving-related inputs being received at least partly via the wireless network connection. Furthermore, the one or more data sources can include an original equipment manufacturer (OEM) server which receives data from the vehicle via a wireless connection with the vehicle. The data at the OEM server can include at least one of ADAS activation data associated with the vehicle, telematics data associated with the vehicle, or built sheet data associated with the vehicle.

In one implementation, a computer-readable non-transitory memory device storing instructions that, when executed by a one or more processors, performs operations including receiving a plurality of driving-related inputs including advanced driving assistance system (ADAS) usage data collected from one or more data sources, the one or more data sources can include a component of an advanced driving assistance system (ADAS) operating in a vehicle; determining one or more vehicle operation behavior values based on the plurality of driving-related inputs, the one or more vehicle operation behavior values can correspond to one or more risk-related events identified from the plurality of driving-related inputs; generating an ADAS-based target output by using the one or more vehicle operation behavior values and at least one of the plurality of driving-related inputs to detect the one or more risk-related events; and/or sending, to another device separate from the one or more processors, a communication (e.g., an instruction or a message) based on the ADAS-based target output.

In one implementation, the one or more vehicle operation behavior values can include a predefined acceleration value over a predefined amount of time, and/or a velocity direction angle relative to a road direction; and/or generating the ADAS-based target output can include determining an accident occurrence based on the predefined acceleration value over the predefined amount of time or the velocity direction angle relative to the road direction. Also, sending the instruction or the message can include sending, responsive to determining the occurrence of the accident, at least one of an accident alert to a mobile device associated with the computing system, a pricing variable to a service pricing model, and/or a tow request to a device associated with a tow service. The operations can further include performing, at the vehicle and responsive to the instruction, an autonomous braking action or an autonomous acceleration action. Additionally, the one or more data sources can include a mobile device and an original equipment manufacturer (OEM) server; and/or determining the one or more vehicle operation behavior values can include combining location data or motion data from the mobile device with ADAS feature activation data from the OEM server.

In one implementation a method of vehicle monitoring and control can include receiving a plurality of driving-related inputs including advanced driving assistance system (ADAS) usage data collected from one or more data sources, the one or more data sources including a component of an ADAS operating in a vehicle; determining one or more vehicle operation behavior values based on the one or more vehicle operation behavior values correspond to one or more risk-related events identified from the plurality of driving-related inputs; generating, using the one or more processor of the computing system executing the computer-readable instructions stored on the non-transitory storage media, an ADAS-based target output by providing the one or more vehicle operation behavior values and at least one of the plurality of driving-related inputs to the system to detect patterns from the one or more risk-related events (e.g., based on a comparison to one or more threshold values); and/or causing device separate from the computing system to receive a communication (e.g., an instruction or a message) based on the ADAS-based target output.

In one implementation, the ADAS usage data can include at least one of a number of ADAS feature activations, a time of an ADAS feature activation, an ADAS feature setting parameter, an indication of ADAS feature enablement or disablement, or an ADAS feature alert. The ADAS usage data can include a change to the ADAS feature setting parameter corresponding to a user input received from a driver of the vehicle, and/or the ADAS-based target output can consider the change as an increase or a decrease for a risk value of the one or more risk-related events. Additionally, the method can further include training the deep-learning model on a training dataset including historical policy pricing information. Moreover, determining the one or more vehicle operation behavior values can include identifying a high-risk behavior pattern corresponding to donuts, street racing, or other high-risk activities.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example system including a vehicle monitoring and control platform.

FIG. 2 is an example system including a vehicle monitoring and control platform with a data collection system, which can form at least a portion of the example system of FIG. 1.

FIGS. 3A-3C illustrates an example system including a vehicle monitoring and control platform with a vehicle/driver operation assessment system, which can form at least a portion of the example system of FIG. 1.

FIG. 4 illustrates an example system including a vehicle monitoring and control platform with a dynamic risk control model, which can form at least a portion of the example system of FIG. 1.

FIG. 5 illustrates an example network environment for implementing a vehicle monitoring and control platform, which can form at least a portion of the example system of FIG. 1.

FIG. 6 illustrates an example computing system for implementing a vehicle monitoring and control platform, which can form at least a portion of the example system of FIG. 1.

FIG. 7 illustrates an example method of vehicle monitoring and control, which can be performed by any of the example systems depicted in FIGS. 1-6.

### DETAILED DESCRIPTION

Aspects of the presently disclosed technology generally relate to systems, methods, and devices for monitoring and controlling operations of a vehicle using one or more advanced driving assistance system (ADAS) features, and/or generating ADAS-based target outputs (e.g., an alert, an autonomous vehicle action, a pricing variable, and so forth). The technology disclosed herein can be implemented with vehicles using ADAS features to improve vehicle safety by automatically deploying a corrective vehicle action to avoid hazardous situations.

Since these features are deployed when risky driving events occur, in some instances, the systems disclosed herein can assess the number and types of activations to determine a relative risk value associated with the vehicle and/or the driver. The systems disclosed herein can perform modelling based on objective, data-driven indicators of actual use of the ADAS features, rather than the mere presence or availability of the ADAS features. For instance, a number of activations of particular ADAS features can be measured and/or calculated as a ratio of number of feature activations to number of vehicle uses or miles driven and/or at various predefined speeds. Furthermore, these systems, methods, and devices are rooted in the modern technological field of electric vehicle control systems and, as such, the technology disclosed herein can be integrated into many practical applications.

Additional advantages of the disclosed technology will become apparent from the detailed description below.

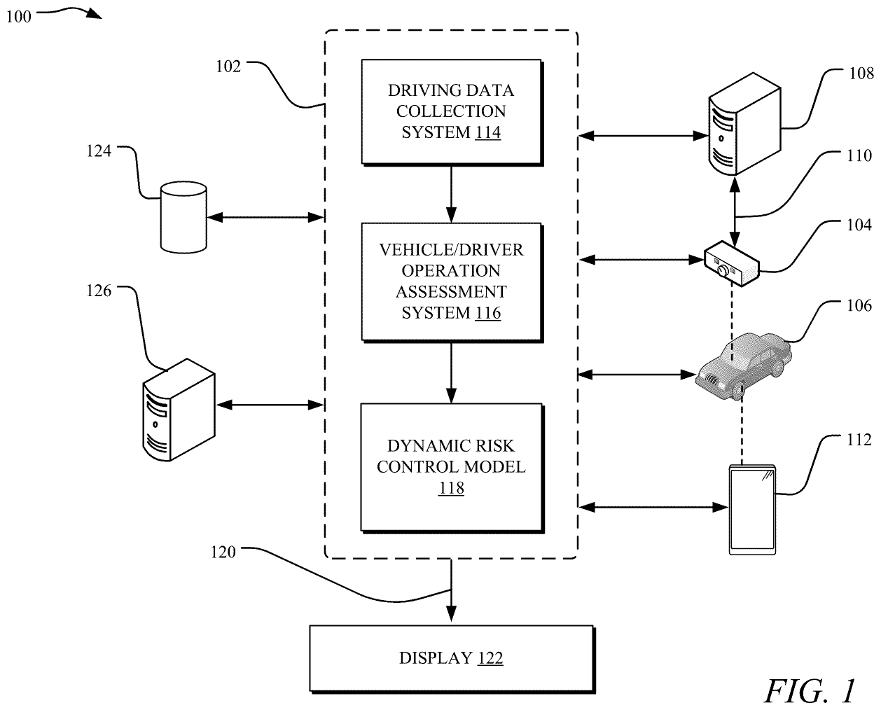

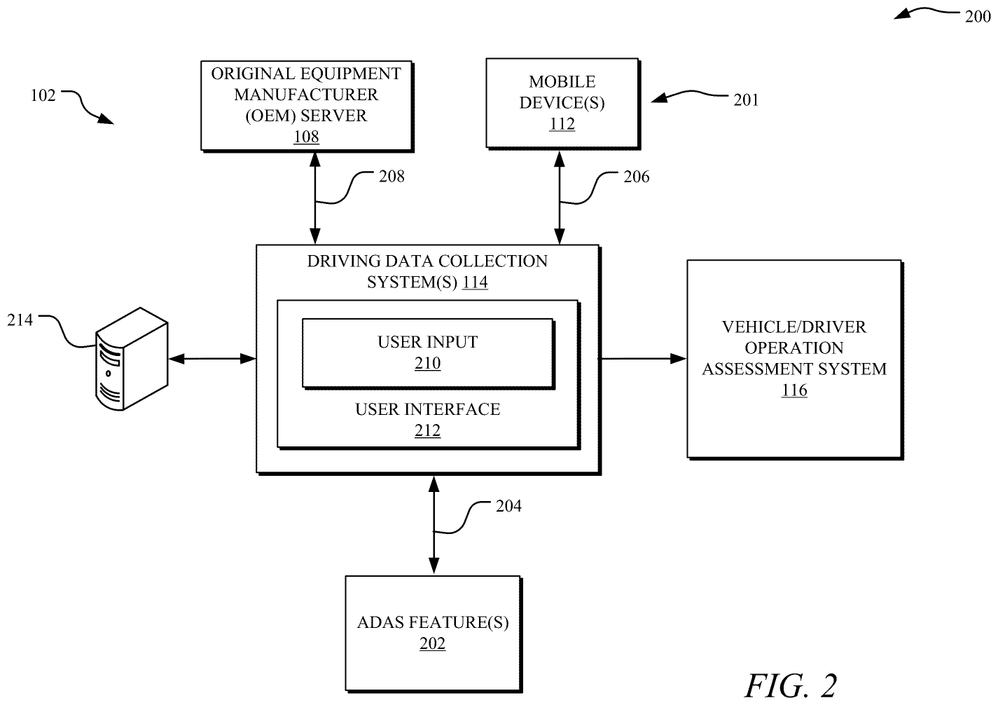

To begin a detailed description of an example system 100, reference is made to FIG. 1. In one implementation, the example system 100 includes a vehicle monitoring and control platform 102 for receiving data from various data sources and controlling operation of various system components accordingly. For instance, the vehicle monitoring and control platform 102 can receive data from an advanced driving assistance system (ADAS) 104 operating in a vehicle 106. The ADAS 104 can communicate with an original equipment manufacturer (OEM) server 108 and/or an OEM application via a wireless communication network and can transmit ADAS-related data 110 to the OEM server 108. The OEM server 108 can, in turn, send the ADAS-related data 110 to the vehicle monitoring and control platform 102. Additionally or alternatively, the vehicle monitoring and control platform 102 can receive the ADAS-related data 110 from other sources, such as directly from the vehicle 106 and/or the ADAS 104. Moreover, the vehicle monitoring and control platform 102 can receive driving-related inputs from other data sources, such as one or more mobile devices(s) 112 associated with the driver or passenger(s). A driving data collection system 114 of the vehicle monitoring and control platform 102 can include algorithmic components to communicate with and receive data from the different data sources, as discussed in greater detail below regarding FIG. 2.

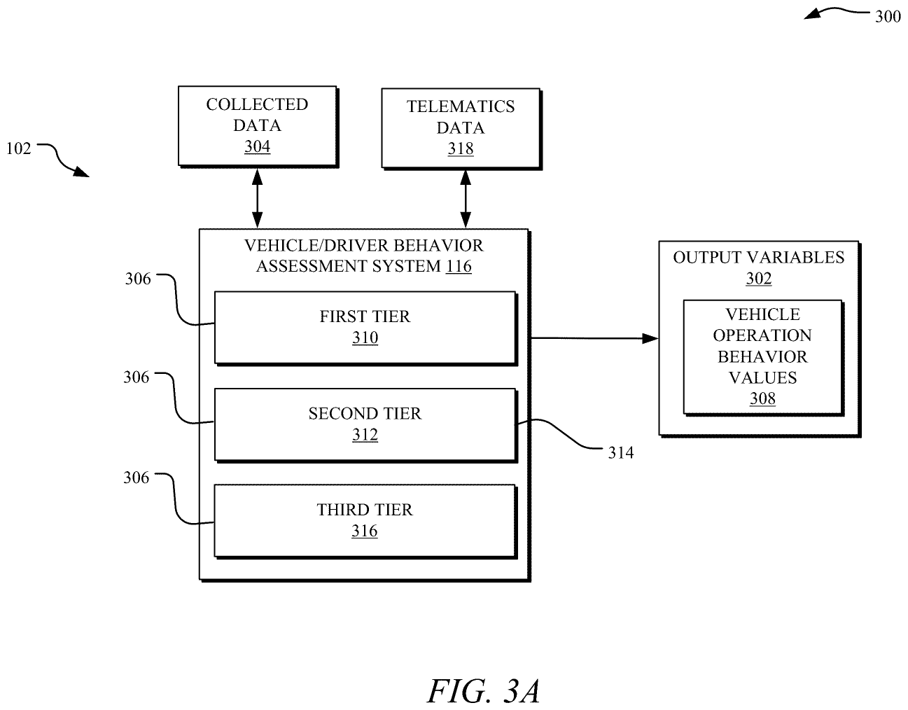

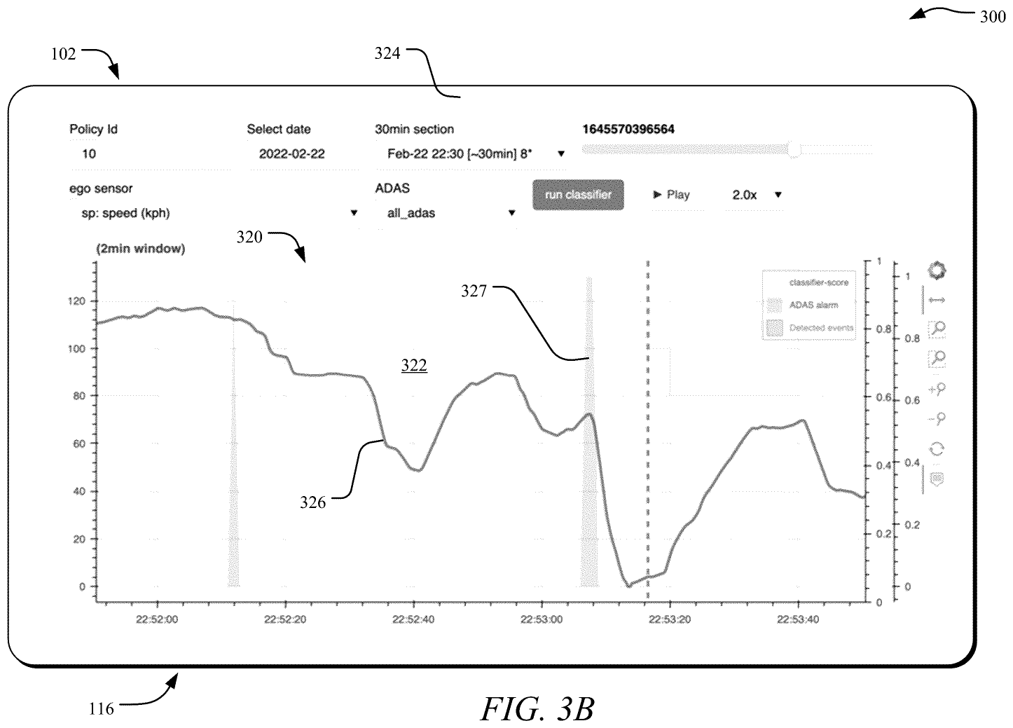

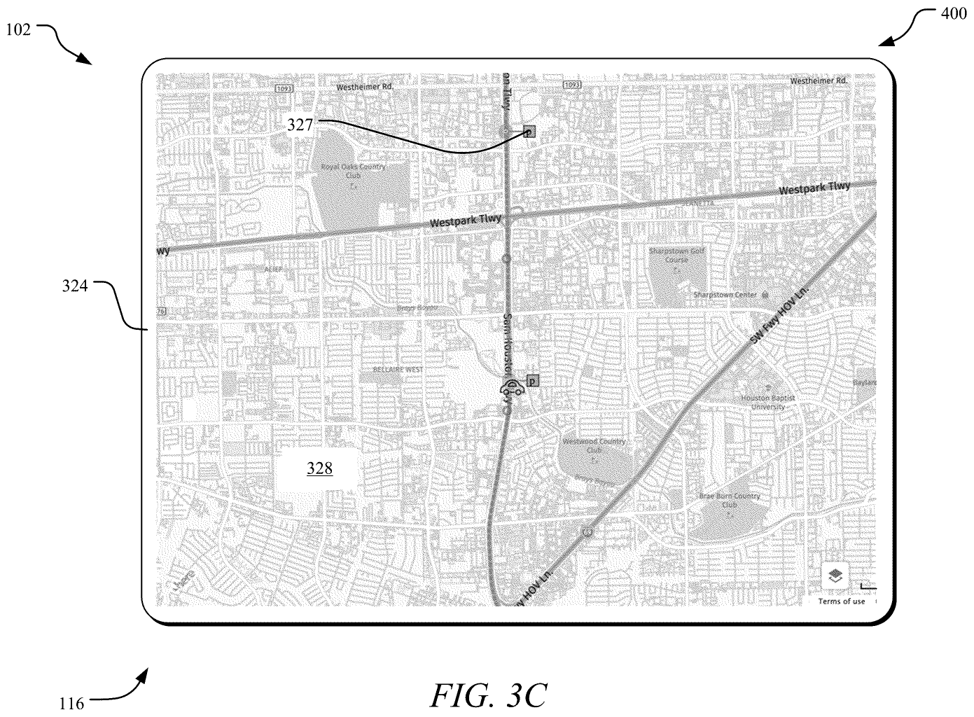

Furthermore, the vehicle monitoring and control platform 102 can include a vehicle/driver operation assessment system 116, discussed in greater detail below regarding FIGS. 3A-3C. The vehicle/driver operation assessment system 116 can include algorithmic components to determine one or more vehicle operation behavior values based on the received ADAS-related data 110 and/or other driving-related inputs (e.g., mobile device data, telematics data, third-party server data, and/or combinations thereof). The vehicle/driver operation assessment system 116 can provide these output variables to a dynamic risk control model 118 which can generate an ADAS-based target output 120 based on the vehicle operation behavior values. An indication of the ADAS-based target output 120 can be presented on a display 122 (e.g., of the mobile device(s) 112 or a dashboard computing device). Additionally or alternatively, the dynamic risk control model 118 can generate and send one or more instructions to other components of the vehicle 106, for instance, to perform an autonomous vehicle action responsive to the vehicle operation values. The vehicle monitoring and control platform 102 and/or various portions, modules, and/or software components discussed herein (e.g., the driving data collection system 114, the driver operation assessment system 116, and/or the dynamic risk control model 118) may be stored at one or more databases 124 as computer-readable instructions executable by one or more processors, such as one or more servers 126.

Turning to FIG. 2, an example system 200 includes the driving data collection system(s) 114 for collecting driving-related data inputs from the different data sources 201. It is to be understood that the system 200 depicted in FIG. 2 can be similar to, identical to, or form at least a portion of the system 100 of FIG. 1.

In some instances, the data source(s) 201 includes ADAS feature(s) 202 that generate vehicle sensor data 204. For instance, the different data sources 201 can include at least one of a safety seat belt sensors, a safety vehicle proximity system, an adaptive cruise control system, an adaptive headlight, a traffic sign recognition system, an intelligent parking assist system, a lane departure warning system, a rear collision warning system, a lane departure assist system, a forward collision alert system, a blind spot monitoring system, a cross traffic alert system, a collision avoidance system, a pedestrian detection system, a driver status monitoring system, a partial and/or full autonomous control (e.g., autonomous braking, accelerating, steering, light activation, etc.), combinations thereof, and the like. This driving-related data generated and/or received from the different ADAS features, can include different types of vehicle sensor data (e.g., ADAS data and/or telematics data).

The vehicle sensor data 204 generated by the ADAS feature(s) 202 and/or other sensors of the vehicle 106 can include position data, speed data, odometer data, longitudinal and/or lateral acceleration data, and so forth. The vehicle monitoring and control platform 102 from the OEM server 108 (and/or the OEM server 108 from the ADAS 104) can pull this data, such as position data, at a predetermined data pull interval (e.g., 1 second, 5 seconds, 10 seconds, 30 seconds, 1 minutes, 5 minutes 10 minutes, 30 minutes, 1 hour, etc.). Moreover, the vehicle monitoring and control platform 102 and/or the OEM server 108 can pull the vehicle sensor data 204 at a particular frequency (e.g., 1 Hz, 5 Hz, 10 Hz, etc.), such as the speed data, lateral acceleration data, longitudinal acceleration data, and/or odometer data.

Furthermore, the ADAS-related data 110 can include various combinations of data from the different ADAS component(s). For example, the ADAS-related data 110 can include one or more of adaptive cruise control system data (e.g., set speed data, speed adjustment data, and so forth), forward collision warning alert data, auto brake data, automatic emergency braking system data, lane keeping assist activation system data, lane departure warning alert system data, vehicle stability control system data, traction control system data, wiper system data, combinations thereof, and so forth. Any of these types of ADAS-related data 110 can be associated with a timestamp and/or a time of use, a vehicle speed during use, a frequency of use, a duration of use, a location of detected object or vehicle, a distance to detected object or vehicle, a speed of detected object vehicle, a response to alert time, a response to alert type, an intensity of alert, a type of alert, a lane position, and so forth. Furthermore, as discussed below, the different data types can be pulled and combined from different data sources to generate various tiers of vehicle operation behavior values, for instance, by combining mobile device data 206 with OEM data 208 (e.g., the ADAS-related data 110).

In some examples, the data source(s) 201 can also include mobile device sensors and/or a built sheet with Adaptive Cruise Control and/or Blind Spot Monitoring. Moreover, the data source(s) can include direct sensor data from the ADAS features 202 (e.g., Adaptive Cruise Control, Blind Spot Monitoring, lane departure warning system, and/or forward collision warning system), sent directly to the applications of the vehicle monitoring and control platform 102, bypassing the OEM server 108. Furthermore, the data source(s) 201 can include user inputs 210 or driver inputs received at a user interface 212, such as a driver or passenger input activating or deactivating a feature of the ADAS component(s), changing a setting of a feature of the ADAS component(s), or so forth. The driving-related input data can also be wheel speed data from a wheel speed sensor and/or can include an indication of damage to one or more sensors (e.g., as an indicator of impact severity). Moreover, the driving-related input data can be received from one or more public records servers and/or weather databases. For instance, the driving-related input data can include weather conditions, road conditions, road types, population density, road construction reports, police reports, and so forth. As noted above, any of the data collected or generated by the driving data collection system(s) 114 can be timestamped for usage by the driver operation assessment system 116 and/or the dynamic risk control model 118.

Furthermore, the driving data collection system 114 can receive driving-related input data from the mobile devices(s) 112. Such mobile device data can include GPS data, accelerometer data, motion data, microphone data, camera data, and so forth. The driving data collection system 114 can aggregate or combine this data from the different data sources 201, such as data from the ADAS 104 and the mobile devices(s) 112. For instance, the vehicle monitoring and control platform 102 can have one or more first authentication/security arrangements with the mobile devices(s) 112, and the vehicle monitoring and control platform 102 can have one or more second authentication/security arrangements with the OEM server 108 to provide access to OEM the servers 108, such as a security access agreement between multiple different servers of different OEMs and one or more hosting servers 214 of the vehicle monitoring and control platform 102. In some scenarios, the vehicle monitoring and control platform 102 can ingest data sets from one or more OEM servers 108 (e.g., a plurality of OEM servers 108 corresponding to a plurality of OEM companies), can normalize the data set, and/or can extract valuable analytic outputs from the normalized data set.

Referring to FIGS. 3A-3C, an example system 300 can include a vehicle/driver operation assessment system 116 which can calculate output variables 302 from the data collected by the driving data collection system 114 (e.g., collected data 304). The vehicle/driver operation assessment system 116 can categorize data for a particular vehicle (e.g., with multiple drivers), and/or for a particular driver (e.g., with multiple vehicles). It is to be understood that the system 300 depicted in FIGS. 3A-3C can be similar to, identical to, or form at least a portion of the system 100 of FIG. 1.

Furthermore, in some examples, the output variables 302 can be categorized into one or more different tiers 306 of vehicle operation behavior values 308 based on, in one example, the number of data inputs used to generate the vehicle operation behavior value 308 and/or a number of calculations performed with the data inputs. For instance, a lower or first tier 310 of vehicle operation behavior values 308 can include a hard braking event, a speeding event, a distracted driving event, a trip consistency time of day associated with the event, and/or a duration associated with the event. The vehicle operation behavior values 308 of the first tier 310 can be determined based on one, two, three, or more vehicle data inputs, such as vehicle speed data, vehicle location data, brake activation data, accelerator activation data, and/or vehicle interior data. A second tier 312 of vehicle operation behavior values 308 can be a middle tier 314 in terms of number of vehicle data inputs and/or a complexity in which the vehicle data inputs are combined, such as by combining additional inputs of ADAS-related data 110 or mobile device data 206 with one of the vehicle operation behavior values 308 of the lower tier. For instance, the second tier of vehicle operation behaviors can include contextual speeding data, miles driven by speed limit, miles driven by speed of vehicle, and so forth. A third tier 316 of vehicle operation behavior values 308 can be an upper tier, or a highest complexity tier, and can include contextual braking (e.g., per time of day, within or deviated from a routine, etc.), hard braking by speed, and/or hard braking relative to a speed limit. The different tiers 306 can incorporate road or weather data. Furthermore, the vehicle operation behavior values 308 in the various tiers can include a hard/extreme braking event, an acceleration value or a steering jerk event, a sharp cornering event (e.g., a lateral acceleration measurement) with an ABS activation, a lane-keep assist activation event, a traction control activation event, a vehicle stability activation event, a contextual speeding event, a rolling stop at a stop sign event, another high risk even derived from the models, combinations thereof, and so forth.

Different examples of the vehicle monitoring and control platform 102 can include different combinations of tiers to match particular processing capabilities and/or network connection capabilities of computing devices executing the disclosed operations, or to match particular products or services provided by the vehicle monitoring and control platform 102. Furthermore, any of the events can be scaled or weighted based on various risk-impacting factors, such as a population density factor (e.g., with higher population density scaling to higher risk and lower population density scaling to lower risk), time of day, and so forth. By analyzing the mobile device data 206, the ADAS-related data 110 (e.g., from an OEM server 108 and/or via a connection with the ADAS 104), vehicle sensor data, and/or combinations thereof, these output variables 302 can represent events of vehicle/driver behavior in a quantified value form.

In some examples, based on a particular combination of sensor data combined with a stop time after an event, an accident can be identified with a location and time of the accident. Furthermore, a speed and an acceleration at the time of the accident (e.g., for a range of time before and/or after the incident) can be used. Additionally, or alternatively, vehicle behavior values after the accident can help to derive a severity of the impact, such as a movement after impact to a shoulder or driveway, a towing action, etc. Moreover, the vehicle/driver operation assessment system 116 can determine an occurrence, severity, or impact of an accident based on a speed value, an acceleration value, and/or an angle of impact (e.g., a forward movement angle with respect to a road line, a building line, an object line, or so forth).

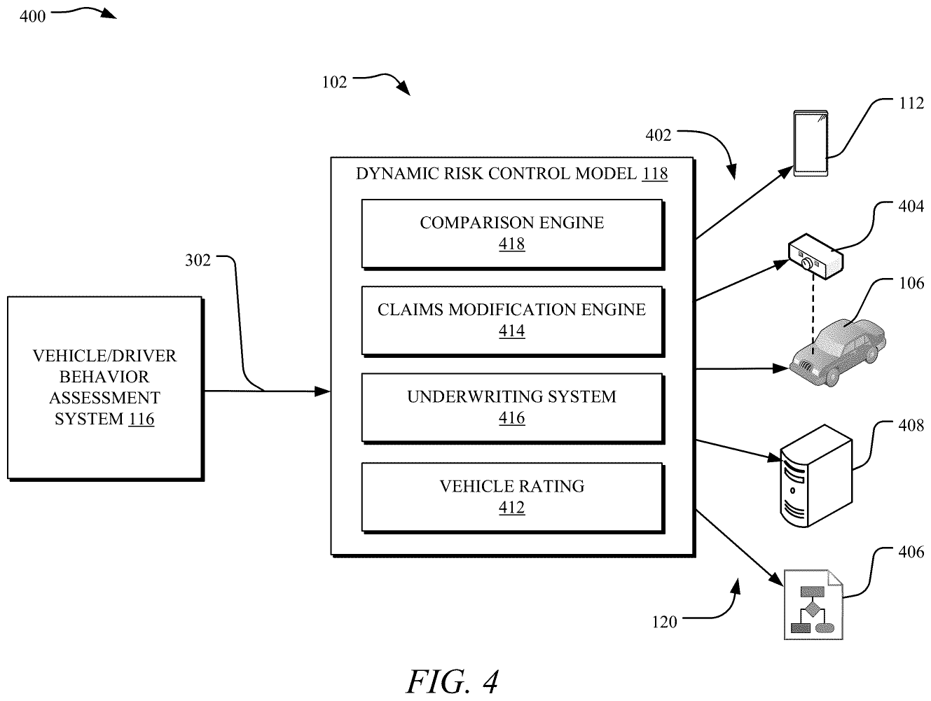

Different ratings, rankings, and/or values (e.g., scaled and/or normalized values) indicating a degree of intensity or significance can be assigned to the events identified as output variables 302 by the vehicle/driver operation assessment system 116, for instance, based on a comparison of how the value deviates from average values in historical data sets of that user or other groups of drivers (e.g., demographically similar drivers). The output variables 302 can be provided to a to a predictive model to generate the target outputs discussed below regarding FIG. 4.

Additionally, other output variables can be calculated from the ADAS-related data 110, other OEM data 208, telematics data 318, and/or the mobile device data 206, which can result in improved predictiveability for the models disclosed herein. For instance, the vehicle/driver operation assessment system 116 can determine, from the driving related input data, an annual mileage value, a hard braking event value, a speeding 15 mph over the speed limit event value, a phone unlocking over 10 mph event value, a speeding on the weekends event value, a number of pre-crash alarms value, a number of pre-crash brakes value, a number of traction control activations value, a number of automatic braking system activations value. In some examples, the system can determine one or more ratio values, which can include a number of any of these event values per a number of miles or per a number of other vehicle event values (e.g., a number of hard braking events per 100 miles, a number of vehicle stability activations per 100 miles, a number of lane assist events per 100 miles, and so forth). In some examples, a particular ratio value can be received from the OEM server 108 and/or can be an event per number of miles, or another number of vehicle operations ratio, according to a data file format of the OEM server 108. Furthermore, certain driving behavior event profiles can be identified from the data by the predictive models of the vehicle/driver operation assessment system 116, based on labelled training data of the certain driving behavior event profiles, such as identifying donuts in a parking lot behavior or street racing behavior.

As shown in FIGS. 3A-3C, in some examples, the vehicle/driver operation assessment system 116 can combine multiple data layers 320 together into an aggregated data file 322, by way of example, for presentation at a graphical user interface (GUI) 324 of the vehicle/driver operation assessment system 116. For example, wheel speed data 326, which can include four separate data streams for the four wheels based on wheel speed sensors, can be combined with location data, time data, and/or event data, and presented via one or more data visualizations (e.g., graphed over time). In some examples, a sequence of events can be determined from the overlayed data, such as a series of particular events 327 (e.g., stopping events, turning events, acceleration events, etc.), which can be overlaid with the wheel speed data 326, and/or the location data (e.g., via presentation of a driving risk event map 328). Furthermore, the GUI 324 can include one more interactive interface elements 330 for selecting which types of data or events are combined and/or displayed at the GUI 324 (e.g., high risk events, acceleration events, braking events, cornering events, collision events, combinations thereof, and so forth).

In some scenarios, the vehicle/driver operation assessment system 116 can include one or more machine learning models which can be trained with historical data and/or can be used to determine statistically relevant patterns from the behavioral metrics. For instance, the vehicle/driver operation assessment system 116 can be trained with historical ADAS data, historical telematics data, insurance claims data, pricing data, a frequency of accidents under certain/different conditions data, and/or on a severity of accidents under certain/different conditions data. The vehicle monitoring and control platform 102 can be trained on pricing data indicating insurance price rates and/or adjustments corresponding to accident data and/or risk behavior related data. Scores and rankings associated with the determinations made by the vehicle/driver operation assessment system 116 can be aggregated and/or weighed, compared to one or more predetermined threshold values (e.g., stored in the database(s) 124). Calculated values can be compared to average vehicle behavior metrics and/or average score values determined from historical data and/or a deep-learning training data set. From these comparisons, various ranking values for the vehicle operation behavior values can be calculated and outputted. In some scenarios, output variables 302 can include quantifications of a risk-level of the behavior of the vehicle, a risk-level of the behavior of the driver, and/or a likelihood of an accident. In some scenarios, one or more threshold values can be used and/or a first deep-learning model of the vehicle/driver operation assessment system 116 can be trained to calculate the output variables 302 representing the vehicle operation behavior values 308. A second deep-learning model of the dynamic risk control model 118, additionally or alternatively, can be trained using similar/identical techniques or different techniques to generate the target outputs from the output variables 302, as discussed in greater detail below.

Referring to FIG. 4, an example system 400 shows the dynamic risk control model 118 of the vehicle monitoring and control platform 102 for generating one or more ADAS-based target outputs 402. It should be understood that the system 400 depicted in FIG. 4 can be similar to, identical to, or form at least a portion of the system 100 of FIG. 1.

In some examples, the vehicle monitoring and control platform 102 can generate the one or more ADAS-based target outputs 402 based on a percentage of usage of the ADAS features determined from the output variables 302, such as a percentage of use of a navigation feature. Furthermore, the one or more ADAS-based target outputs 402 can be based on an amount of risk associated with an autonomous vehicle intervention (e.g., instances where the vehicle automatically takes action to minimize risk) identified from the output variables 302. In some variations, the one or more ADAS-based target outputs 402 are based on deriving riskier driving behavior from the output variables 302 representing autonomous vehicle technology features and assigning a rating factor based on the loss performance of feature activations which are specifically designed to minimize risk events. Additionally or alternatively, additional vehicle data can be assessed to detect any correlation between ‘riskier’ driving behaviors and engagements of the ADAS features 202 or an autonomous mode feature. For instance, the vehicle monitoring and control platform 102 can determine that engagement of adaptive cruise control experiences safer correspond to safer driving/vehicle behaviors. In some examples, this higher granularity data and/or real-time use of output variables 302 to generate one or more ADAS-based target outputs 402 can increase responsiveness and effectiveness of systems providing aid or services to the vehicle. For instance, the dynamic risk control model 118 can output an instruction to an autonomous control system 404 of the vehicle 106 to perform an autonomous vehicle action. Moreover, the vehicle monitoring and control platform 102 can provide an improved match price to risk for pricing models 406 operating at third-party servers 408. Furthermore, telematics data 318 can be combined with the one or more ADAS-based target outputs 402 to form a vehicle rating 412 to represent the different ADAS usage events and corresponding risk-levels associated with the ADAS usage events.

In some instances, the one or more ADAS-based target outputs 402 can include one or more alerts, such as text or audio alert presented at the display 122, at the mobile device 112, or any other device of the vehicle monitoring and control platform 102. The alert can present a visual or audible warning about a high-risk event and/or a recommendation. Moreover, the alert can indicate that the vehicle monitoring and control platform 102 may generate additional one or more ADAS-based target outputs 402 which may impact the driver, such as generating a pricing variable for an insurance policy associated with the driver, other notifications sent to towing services or emergency services, and/or additional charges to the driver for assistance services. Additionally, the one or more ADAS-based target outputs 402 can include a communication sent to a device. The communication can be message such as a textual, human-readable message or an audio message. Additionally or alternatively, the communication can be an instruction, such as a machine-readable instruction to perform a physical machine operation and/or a software operation (e.g., an API call). Moreover, the communication can include a request, which can be sent to a device associated with a third-party or service provider, such as a request for driver history data or insurance data from the third-party server 408. In scenarios with a plurality of drivers using the vehicle monitoring and control platform 102, the vehicle monitoring and control platform 102 can be configured to generate an alert to be sent to other drivers for display at their mobile devices and/or vehicles. The one or more ADAS-based target outputs 402 can also include an instruction to one or more vehicle components to perform a car action, such as adding brake force, adding acceleration force, or moving the steering wheel (e.g., an autonomous vehicle action). The one or more ADAS-based target outputs 402, in some instances, can be generated at a high frequency and/or with a high degree of granularity based on a dynamic and/or real-time input of data to and from the driving data collection system 114.

In some examples, the one or more ADAS-based target outputs 402 can include a pricing output for a vehicle system and/or a service system (e.g., a vehicle upgrade system, an insurance system, a greenhouse policy eligibility system, and so forth). For instance, the one or more ADAS-based target outputs 402 can include an ADAS-based alert of the detection of a risky event using the deep-learning model, and/or a pricing model 406 adapted, modified, or enhanced to include the ADAS-based alert. In some examples, the deep-learning model can be trained on historical claims data (e.g., including submitted claim information and claim outcome data), aggregated historical loss data, and/or various pricing models. In some instances, the operations of the deep-learning model can be performed at the server 126. Additionally or alternatively, an application operating on the mobile device 112 can include the deep-learning algorithm trained on these datasets.

Furthermore, in scenarios where the server 126 is a service provider server, the vehicle monitoring and control platform 102 can include a claims modification engine 414 which extracts accident locations from the OEM data 208 received from the OEM server 108 to derive variables of interest for insurance claim processing or actuarial analysis. Moreover, the vehicle monitoring and control platform 102 can include an underwriting system 416 that can incorporate the ADAS-based alert and/or can identify one or more abnormal data elements which correspond to identifying an unusual driving behavior. Additionally or alternatively, data can be collected from one or more mobile device 112 by a comparison engine 418, which can determine overlapping data between the OEM data 208 and the mobile device data 206 (e.g., location data, speed data, acceleration data, etc.). In some scenarios, the comparison engine 418 can compare braking events of the mobile device data 206 with braking events of the OEM data 208, and/or any other events related to a service request action performed by the driver, determining a tow event, displaying crash event information at a mobile device 112, initiating an emergency phone call, filing an insurance claim or claim adjustment request, and so forth.

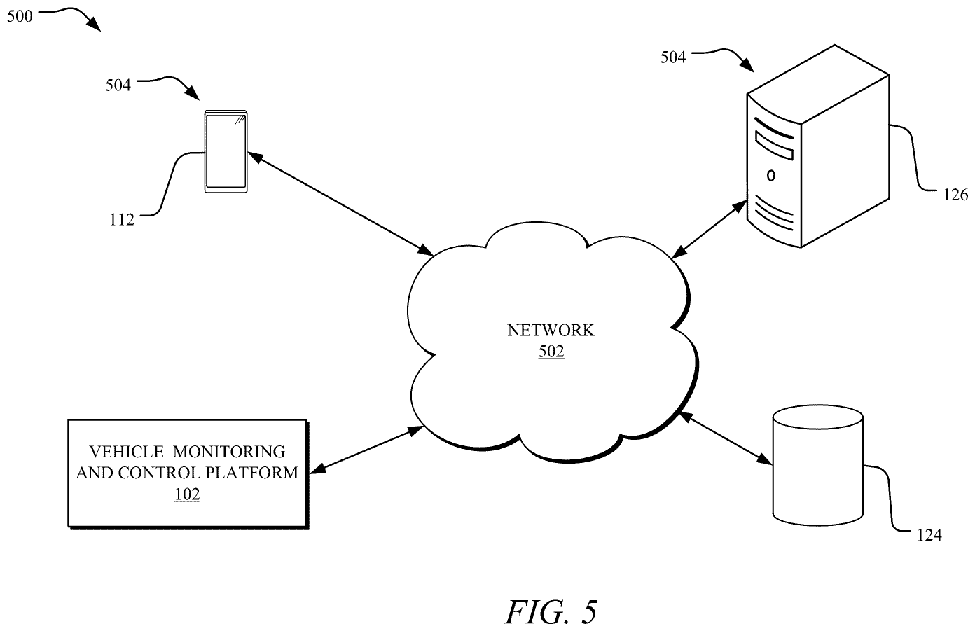

Turning to FIG. 5, an example network environment 500 for implementing the system 100 with the vehicle monitoring and control platform 102 is illustrated. The network environment 500 can include a network 502 for connecting the vehicle monitoring and control platform 102 (e.g., hosted on the host server(s) 126) to the database(s) 124, the mobile devices(s) 112, and/or any other one or more computer systems 504 discussed herein.

In some examples, a server 126 can host the network environment 500. In one implementation, the server 126 also hosts a website or an application that users may visit to access the vehicle monitoring and control platform 102, the ADAS 104, the OEM server 108, the driving data collection system 114, the vehicle/driver operation assessment system 116, the dynamic risk control model 118, the ADAS-related data 110, the output variables 302, the one or more ADAS-based target outputs 402, and/or other software components or outputs discussed herein. The server 126 may be one single server, a plurality of servers with each such server being a physical server or a virtual machine, or a collection of both physical servers and virtual machines. In another implementation, a cloud hosts one or more components of the vehicle monitoring and control platform 102. The vehicle monitoring and control platform 102, the computing devices 504, the server 126, and other resources connected to the network 502 may access one or more additional servers for access to one or more websites, applications, application programming interfaces (API)s, web services interfaces, and/or the like.

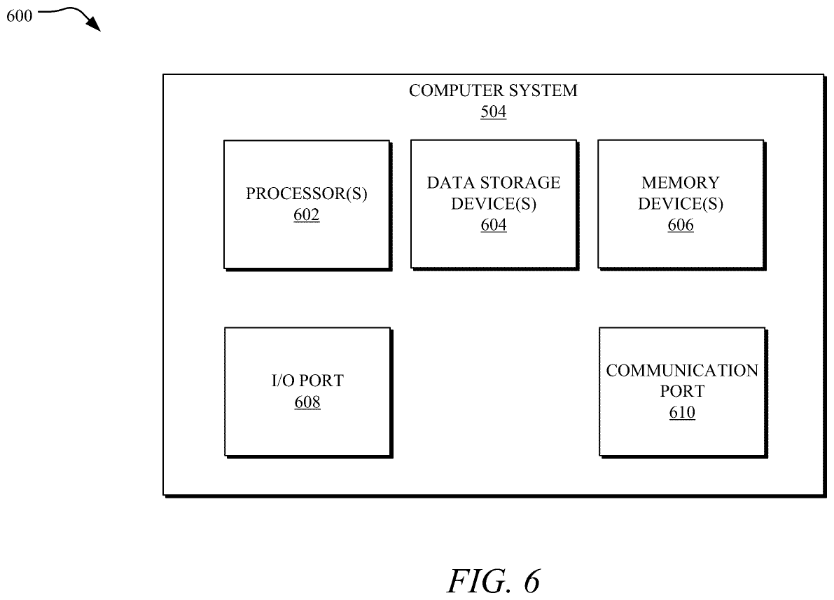

Referring to FIG. 6, a detailed description of an example system 600 including the computing system 504 having one or more computing units to implement various systems and methods discussed herein is provided. The computing system 504 may be applicable to the mobile device 112, the vehicle 106, the OEM server 108, the server 126, the database(s) 124, the telematics device of the vehicle 106, an onboard vehicle computing device, other home or personal device(s), and/or other computing or network devices discussed herein. It will be appreciated that specific implementations of these devices may be of differing possible specific computing architectures.

The computer system 504 may be a computing system capable of executing a computer program product to execute a computer process. Data and program files of the vehicle monitoring and control platform 102 may be input to the computer system 504, which reads the files and executes the programs therein. Some of the elements of the computer system 504 are shown in FIG. 6, including one or more hardware processors 602, one or more data storage devices 604, one or more memory devices 606, and/or one or more ports 608-610. Additionally, other elements that will be recognized by those skilled in the art may be included in the computing system 504. Various elements of the computer system 504 may communicate with one another by way of one or more communication buses, point-to-point communication paths, or other communication means.

The processor 602 may include, for example, a central processing unit (CPU), a microprocessor, a microcontroller, a digital signal processor (DSP), a graphics processing unit (GPU), and/or one or more internal levels of cache. There may be one or more processors 602, such that the processor 602 comprises a single central-processing unit, or a plurality of processing units capable of executing instructions and performing operations in parallel with each other, commonly referred to as a parallel processing environment.

The computer system 504 may be a single computer, a distributed computer, or any other type of computer, such as one or more external computers made available via a cloud computing architecture. The presently described technology is optionally implemented in software stored on the data storage device(s) 604, stored on the memory device(s) 606, and/or communicated via one or more of the ports 608-610, thereby transforming the computer system 504 in FIG. 6 to a special purpose machine for implementing the operations described herein, and providing many practical applications for the technology. Examples of the computer system 504 include personal computers, terminals, workstations, mobile phones, tablets, laptops, personal computers, wearable devices, multimedia consoles, gaming consoles, set top boxes, and the like.

The one or more data storage devices 604 may include any non-volatile data storage device capable of storing data generated or employed within the computing system 504, such as computer-executable instructions for performing a computer process, which may include instructions of both application programs and an operating system (OS) that manages the various components of the computing system 504. The data storage devices 604 may include, without limitation, magnetic disk drives, optical disk drives, solid state drives (SSDs), flash drives, and the like. The data storage devices 604 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 606 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 604 and/or the memory devices 606, which may be referred to as machine-readable media or computer-readable media. It will be appreciated that machine-readable media may include any tangible non-transitory medium that is capable of storing or encoding instructions (e.g., computer-readable instructions) to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 504 includes one or more ports, such as the input/output (I/O) port 608 and the communication port 610, for communicating with other computing, network, or vehicle devices. It will be appreciated that the ports 608-610 may be combined or separate and that more or fewer ports may be included in the computer system 504.

The I/O port 608 may be connected to an I/O device, or other device, by which information is input to or output from the computing system 504. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 504 via the I/O port 608. The input devices can also convert signals generated via the vehicle monitoring and control platform 102 into input data via the I/O port 608. Similarly, the output devices may convert electrical signals received from computing system 504 via the I/O port 608 into signals that may be sensed as output by a human, such as sound, light, and/or touch. The input device may be an alphanumeric input device, including alphanumeric and other keys for communicating information and/or command selections to the processor 602 via the I/O port 608. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices can convert one form of energy or signal into another for input into or output from the computing system 504 via the I/O port 608. For example, an electrical signal generated within the computing system 504 may be converted to another type of signal, and/or vice-versa. In one implementation, the environment transducer devices sense characteristics or aspects of an environment local to or remote from the computing device 504, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 504, such as, physical movement of some object (e.g., a mechanical actuator for causing the vehicle action).

In one implementation, a communication port 610 is connected to a network 502 by way of which the computer system 504 may receive network data useful in executing the methods and systems set out herein as well as transmitting information and network configuration changes determined thereby. Stated differently, the communication port 610 connects the computer system 504 to one or more communication interface devices configured to transmit and/or receive information between the computing system 504 and other devices by way of one or more wired or wireless communication networks or connections. Examples of such networks 502 or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 610 to communicate one or more other machines, either directly over a point-to-point communication path, over a wide area network (WAN) (e.g., the Internet), over a local area network (LAN), over a cellular (e.g., third generation (3G) fourth generation (4G), or fifth generation (5G)) network, or over another communication means. Further, the communication port 610 may communicate with an antenna or other link for electromagnetic signal transmission and/or reception.

In an example implementation, vehicle monitoring and control software and other modules and services may be embodied by instructions stored on the data storage devices 604 and/or the memory devices 606 and executed by the processor 602.

In the present disclosure, the methods disclosed may be implemented as sets of instructions or software readable by a device. Further, it is understood that the specific order or hierarchy of steps in the methods disclosed are instances of example approaches. It is understood that the specific order or hierarchy of steps in the method can be rearranged while remaining within the disclosed subject matter.

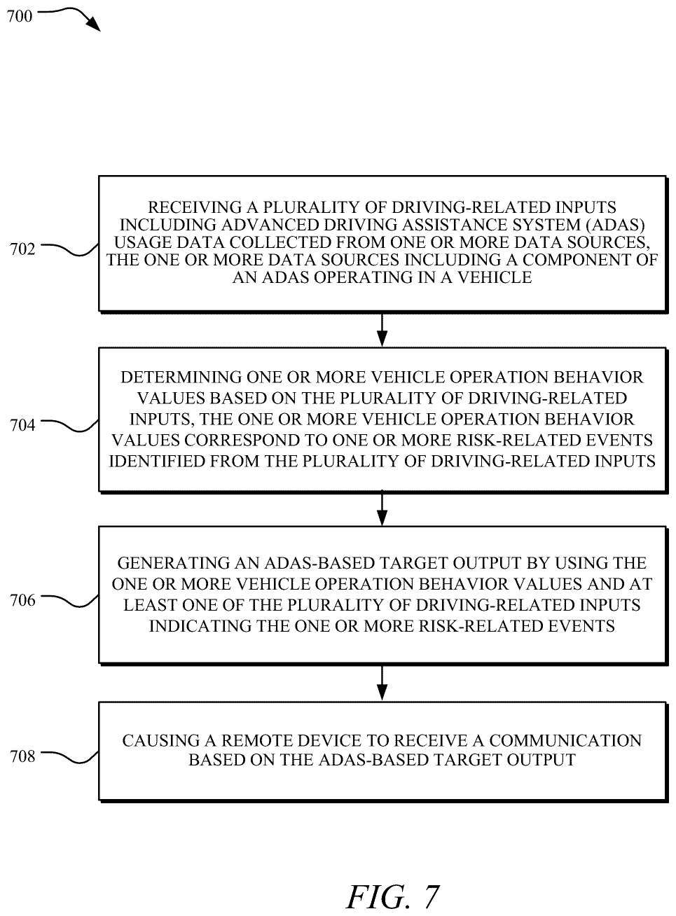

Referring to FIG. 7, example operations of a method 700 of vehicle monitoring and control are depicted. The method 700 shown in FIG. 7 can be performed by any of the systems depicted in FIGS. 1-6.

In some examples, at operation 702, the method 700 can receive a plurality of driving-related inputs including advanced driving assistance system (ADAS) usage data collected from one or more data sources, the one or more data sources including a component of an ADAS operating in a vehicle. At operation 704, the method 700 can determine one or more vehicle operation behavior values, using one or more processor of a computing system executing computer-readable instructions stored on non-transitory storage media, based on the plurality of driving-related inputs, the one or more vehicle operation behavior values correspond to one or more risk-related events identified from the plurality of driving-related inputs. At operation 706, the method 700 can generate, using the one or more processor of the computing system executing the computer-readable instructions stored on the non-transitory storage media, an ADAS-based target output by providing the one or more vehicle operation behavior values and at least one of the plurality of driving-related inputs to the system using one or more threshold values to detect patterns from the one or more risk-related events. At operation 708, the method 700 can cause another device remote from the computing system to receive an instruction or a message based on the ADAS-based target output.

It is to be understood that the specific order or hierarchy of steps in the method(s) depicted throughout this disclosure are instances of example approaches and can be rearranged while remaining within the disclosed subject matter. For instance, any of the operations depicted throughout this disclosure may be omitted, repeated, performed in parallel, performed in a different order, and/or combined with any other of the operations depicted throughout this disclosure.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A system comprising:
a vehicle monitoring and control system obtaining a plurality of driving-related inputs of data collected from one or more data sources, the one or more data sources including a component of an advanced driving assistance system (ADAS) operating in a vehicle;
a controller having at least one processor, the controller determining one or more vehicle operation behavior values based on the plurality of driving-related inputs, the one or more vehicle operation behavior values corresponding to one or more risk-related events identified from the plurality of driving-related inputs; and
one or more deep-learning models generating an ADAS-based target output based on the one or more vehicle operation behavior values and the plurality of driving-related inputs, wherein an indication of the ADAS-based target output is generated for presentation.

2. The system of claim 1, wherein:
the one or more data sources further includes a mobile device associated with a driver of the vehicle and an original equipment manufacturer (OEM) server;
the plurality of driving-related inputs includes location data from the mobile device and ADAS usage data from the OEM server; and
the system combines the location data with the ADAS usage data to identify the one or more risk-related events.

3. The system of claim 2, wherein the component of the ADAS includes at least one of an adaptive cruise control system, a forward collision warning alert system, an anti-lock brake system, an automatic emergency braking system, a lane keeping assist system, a lane departure warning alert system, a vehicle stability control system, a traction control system, or a wiper system.

4. The system of claim 2, wherein the one or more vehicle operation behavior values includes a ratio calculated using one or more ADAS feature activations of the ADAS.

5. The system of claim 4, wherein the one or more ADAS feature activations includes at least one of one or more traction control activations or one or more automatic brake activations.

6. The system of claim 4, wherein the ratio is calculated using the one or more ADAS feature activations over a predefined number of uses.

7. The system of claim 1, wherein the ADAS-based target output includes at least one of an alert message sent to one or more mobile devices, an update to a risk map presented at a display, a request for assistance sent to an emergency response device, a tow request sent to a device associated with a towing service, an instruction to perform an autonomous car action, or a pricing variable for an insurance pricing model.

8. The system of claim 1, wherein the one or more data sources includes a mobile device having a wireless network connection with the vehicle, the mobile device including a touchscreen display, wherein at least some of the plurality of driving-related inputs are received at least in part via the touchscreen display.

9. The system of claim 7, wherein the one or more data sources includes an original equipment manufacturer (OEM) server which receives data from the vehicle via a wireless connection with the vehicle.

10. The system of claim 9, wherein the data at the OEM server includes at least one of:
ADAS activation data associated with the vehicle,
telematics data associated with the vehicle, or
built sheet data associated with the vehicle.

11. A computer-readable non-transitory memory device storing instructions that, when executed by a one or more processors, performs operations comprising:
receiving a plurality of driving-related inputs including advanced driving assistance system (ADAS) usage data collected from one or more data sources, the one or more data sources including a component of an advanced driving assistance system (ADAS) operating in a vehicle;
determining one or more vehicle operation behavior values based on the plurality of driving-related inputs, the one or more vehicle operation behavior values corresponding to one or more risk-related events identified from the plurality of driving-related inputs;
generating an ADAS-based target output by using the one or more vehicle operation behavior values and at least one of the plurality of driving-related inputs to detect the one or more risk-related events; and
sending, to another device separate from the one or more processors, a communication based on the ADAS-based target output.

12. The computer-readable non-transitory memory device of claim 11, wherein:
the one or more vehicle operation behavior values include at least one of a predefined acceleration value over a predefined amount of time or a velocity direction angle relative to a road direction; and
generating the ADAS-based target output includes determining an accident occurrence based on the predefined acceleration value over the predefined amount of time or the velocity direction angle relative to the road direction.

13. The computer-readable non-transitory memory device of claim 12, wherein sending the communication includes sending, responsive to determining the accident occurrence, at least one of:
an accident alert to a mobile device,
a pricing variable to a service pricing model, or
a tow request to a device associated with a tow service.

14. The computer-readable non-transitory memory device of claim 13, wherein the operations further include performing, at the vehicle and responsive to the communication, at least one of an autonomous braking action or an autonomous acceleration action.

15. The computer-readable non-transitory memory device of claim 12, wherein:
the one or more data sources includes a mobile device and an original equipment manufacturer (OEM) server; and
determining the one or more vehicle operation behavior values includes combining location data or motion data from the mobile device with ADAS feature activation data from the OEM server.

16. A method of vehicle monitoring and control, the method comprising:
receiving a plurality of driving-related inputs including advanced driving assistance system (ADAS) usage data collected from one or more data sources, the one or more data sources including a component of an ADAS operating in a vehicle;
determining one or more vehicle operation behavior values based on the plurality of driving-related inputs, the one or more vehicle operation behavior values corresponding to one or more risk-related events identified from the plurality of driving-related inputs;
generating an ADAS-based target output by using the one or more vehicle operation behavior values and at least one of the plurality of driving-related inputs indicating the one or more risk-related events; and
causing another device to receive a communication based on the ADAS-based target output.

17. The method of claim 16, wherein the ADAS usage data includes at least one of one or more ADAS feature activations, a time of an ADAS feature activation, an ADAS feature setting parameter, a change to an ADAS feature status, an indication of ADAS feature enablement or disablement, or an ADAS feature alert.

18. The method of claim 17, wherein the ADAS usage data includes a change to the ADAS feature setting parameter corresponding to a user input received from a driver of the vehicle, and the ADAS-based target output considers the change as an increase or a decrease for a risk value of the one or more risk-related events.

19. The method of claim 16, further including:
training a deep-learning model on a training dataset including historical policy pricing information, the communication is at least partly generated by the deep-learning model.

20. The method of claim 16, wherein determining the one or more vehicle operation behavior values comprises identifying a high-risk behavior pattern corresponding to at least one of donuts or street racing.
